(19) United States
(12) Patent Application Publication
(10) Pub. No.: US 2005/0284146 A1
(43) Pub. Date: Dec. 29, 2005

(54) Solar-power-plants with thermal night-electricity generator

(76) Inventor: Johannes Nikolaus Laing, La Jolla, CA (US)

Correspondence Address: Johannes Nikolaus Laing, 1253 La Jolla Rancho Road, La Jolla, CA, 92037, US

(21) Appl. No.: 10/877,348

(22) Filed: Jun. 28, 2004

(51) Int. Cl. F03G 6/00

(52) U.S. Cl. 60/641.8

(57) ABSTRACT

The invention refers to procedures to bridge the night- and overcast hours when using solar power plants by water splitting during the sunshine hours and combustion of the oxyhydrogen gas during the night hours with devices which are driven by high temperatures like magneto-plasma-dynamic generators and displacement engines without contact between piston and cylinder.

### PRIOR ART

Solar power plants might be the future electricity generators. The disadvantage is their dependence on direct sunlight, which means no power at nighttime. It has been proposed that fossil-fired power plants provide the power over night. But not only do they cause ecological damage by emitting CO₂ and NOₓ, the fact that they run only a few hours per day causes them to be uneconomical.

Fuel cells could be used if hydrogen is produced by the solar generators during sunshine hours, however the high costs of these cells deters this to be economical in dimensions sufficient for public utilities.

### SUMMARY OF THE INVENTION

The invention overcomes these disadvantages. According to the invention the solar power generator produces beside electricity for the grid also electricity to split water molecules into 2H₂ and O₂. The hydrogen and oxygen will be stored for nighttime use. As soon as the solar electricity production falls below the demand, they will be consumed in a highly efficient magneto-plasma-dynamic generator, producing charged ions. This combustion product is a steam plasma with the temperature of a welding torch. It races across a magnetic field that oppositely diverts the positive and negative charge carriers to electrodes running parallel to the gas flow. By this orthogonal splitting of the charge carriers, a large part of the recombination energy converts directly to electricity. Hereby the gas stream looses the energy, which is converted into electricity. The leaving gas-stream then has a lower temperature.

In the last century the magneto-plasma-dynamic generators were proposed as stages for combustion power plants of which a few samples were built. While the theoretical calculation showed that up to 60% of the combustion energy could be converted into electricity, test results showed efficiencies, which did not justify the extra costs. The calculated efficiencies required flame-temperatures above 3,000K. To reach such high temperatures, the combustion gases had to be preheated to 1,300K, which absorbs a large part of the combustion energy. Since in this process a substantial part of the combustion gases consisted of N₂, which had to be preheated and partly oxidized to NOₓ, the process did not only loose sensitive heat but also fusion energy. Because the preheating of the combustion gases could not be avoided this led to the end of the tests.

This disadvantage can be avoided by stoichiometric combustion of oxyhydrogen-gas, which reaches temperatures of 3,300 to 3,500 K. At the same time the forming of the poisonous NOₓ is avoided, which is in the exhaust-gases of all other high temperature processes. Calculations show that the degree of the ionization doubles if temperature increases by only 10%.

Since the part of the gas-stream, which is not ionized and which reaches only a lower Carnot-quality, but still has a temperature of about 2,000 K when it exits as exhaust-gas, the invention intends to use the kinetic and thermal energy of this exhaust gas stream in a gas turbine, which drives an electric generator. This increases the total efficiency of the aggregation of system components. The exhaust gas of said gas turbine still can be used to drive a further thermodynamic machine. As a preferred solution the invention uses the energy of this secondary exhaust gas stream in a hot-vapor water-splitting unit. The heat of this exhaust gas can also be used for a medium-temperature electrolyzer, even the waste heat of the hot steam-unit may be hot enough to improve the efficiency of the electrolyzer. Both methods reduce the amount of solar electricity, which has to be branched off from the daily solar electricity production for water-splitting.

Instead of magneto-plasma-dynamic generators high-temperature Stirling motors or other combustion engines can be used to drive electric generators. The parts of these machines sliding in one another are preferably made from ceramic and have to be gas-lubricated. The invention intends to use a piston-engine, which burns H₂ and O₂ in the stoichiometric proportion 2:1. To create a supporting lubrication layer which warrants no contact between the parts the piston is rotated for instance by an electric motor. The still very hot exhaust gases of these engines can be used in a further positive displacement expander engine or turbine. When the exhaust gases are used in a positive displacement expander engine the invention intends to connect the pistons of the two stages with a common concentrically arranged rod, so that only one electric motor is necessary for the rotation of both pistons.

In solar power plants, which predominantly produce hydrogen for industrial use or motor vehicles, it is intended to use natural gas instead of the valuable hydrogen with oxygen—being a by-product of water splitting—for production of electricity for the night hours. Since the content of carbon in natural gas is much smaller than in all other fossil fuels and the nightly electricity consumption is only a small percentage of the total electricity production, the CO₂-production is negligible compared to that of today's electricity production.

### BRIEF DESCRIPTION OF THE DRAWINGS

FIG. 1 shows the principle diagram with a magneto-plasma-dynamic generator.

FIG. 2 shows a gas-lubricated ceramic motor.

### DETAILED DESCRIPTION OF THE INVENTION

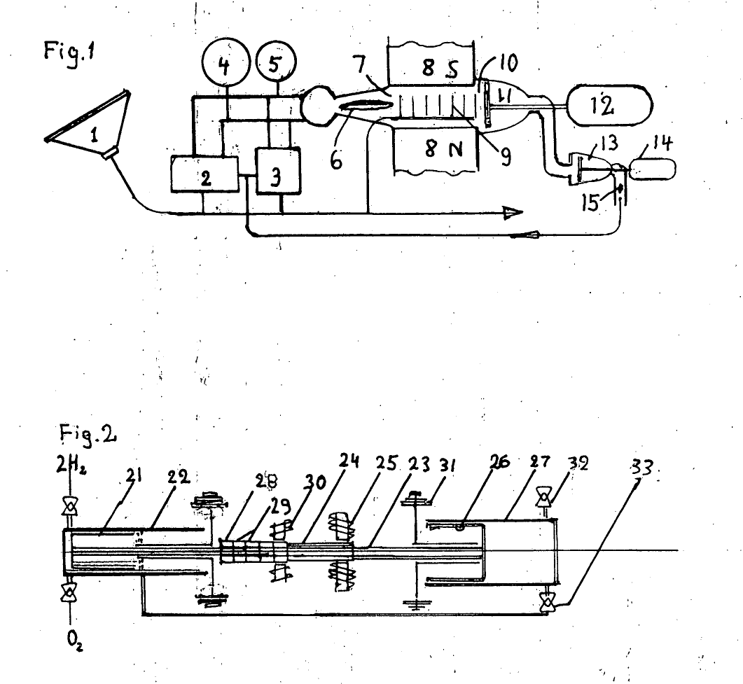

FIG. 1 shows a solar generator 1, an electrolyzer 2, a high temperature steam electrolyzer 3, a gas-storage for H₂ 4, a gas-storage for O₂ 5. The hot gas-stream 6 flows with high velocity through the separating section 7 in which the lines of magnetic field 8 run perpendicular to the direction of the gas-stream 6. The charge carriers will be diverted by the magnetic force according to their charge either to the anode 9 on the front side or to the cathode on the backside so that an electric current is formed. The exiting gas-stream 10 has a lower temperature and therefore a lower Carnot quality than the hot gas stream 6. Its remaining energy is partly used to drive the gas turbine 11, which drives an electricity generator 12. The exhaust gases of gas turbine 11 are used to drive a secondary gas-turbine 13 with a generator 14. The exhaust gas-stream heats the electrolyzers 2 and 3.

FIG. 2 shows a piston 21 in a cylinder 22 in a high-temperature engine which burns hydrogen with pure O₂. The engine piston 21 and the cylinder 22 consist of ceramic material. The piston 21 is connected via a rod 23 with the armature 24 of an electric motor with stator 25 and with the piston 26. An electric motor brings the pistons 21 and 26 to such a high rotating speed that it performs a contact-less move similar to the shaft of an oil-lubricated bearing. Thus both pistons 21 and 26 rotate with the same rpm and both do not need lubricant. The rod 23 carries a permanent magnetic cylinder 28 with a number of magnetic poles 29, which generate AC-electricity in the stator 30. The piston 26 has a larger diameter than piston 21 and its piston head shows in the opposite direction of the head of piston 21 in cylinder 27. The exhaust gas stream 52 of the positive displacement engine is used to drive a secondary gas turbine or piston expander engine. Their exhaust gas will heat the water-splitting devices 2 and 3.

1. Procedure and device to produce electricity by solar electricity generators during nighttime or overcast hours by burning a 2:1 stoichiometric mixture of H₂ and O₂, produced by said solar electricity generator by water splitting during sun shine hours.

2. Device according to claim 1, characterized in that the burning oxyhydrogen gas is conducted with high velocity through a magnetic field of a magneto-plasma-dynamic generator that oppositely diverts the positive and negative charge carriers to electrodes.

3. Combination of a device according to claim 2 with a thermodynamic machine driven by the exhaust gases of said machine which drives an electrodynamic generator.

4. Device succeeding the thermodynamic machine according to claim 3, characterized in that its exhaust gases are used to heat a hot steam water splitting device.

5. Device to use the heat of the exhaust gas of the thermodynamic machine according to claim 3, characterized in that the heat of the exhaust gas is used to heat the electrolyte in an electrolyzer.

6. Device according to claim 3, characterized in that the heat of the exhaust gas of the thermodynamic machine is partly used in a water splitting device according to claim 4 and partly in such a device according to claim 5.

7. Procedure according to claim 1, characterized in that the cascade-like use of the combustion energy of H₂ and O₂ takes place in at least two steps.

8. Procedure according to claim 1 with a combustion motor, whose relatively to each other sliding parts are separated by a gas cushion.

9. Combustion motor according to claim 8, with a piston-cylinder-unit, whose piston rotates around its axis.

10. Combustion motor according to claim 8, characterized in that the exhaust gases of the combustion motor are expanded in a thermodynamic machine.

11. Combustion motor according to claim 10, characterized in that it is succeeded by an expansion motor.

12. Combustion motor according to claim 8, characterized in that the piston of the combustion motor is put in rotation by an electric motor.

13. Combustion motor according to claim 8, characterized in that the centers of the pistons of a primary combustion engine and a secondary expander engine are connected by a rod.

14. Device according to claim 1, characterized in that the combustion takes place without air.

15. Device according to claim 1, characterized in that the waste heat of thermal electricity production processes is used to heat a hot-steam water-splitting device.

16. Solar power plant according to claim 1, characterized in that the sliding parts of a piston engine perform beside their axial movement a rotation, whereby the rpm is so high that the piston also at the dead center positions does not contact its cylinder.

17. Device according to claim 16, characterized in that the pistons are rotated by an electric motor.

18. Device according to claim 17, characterized in that the axial extension of the armature of the electric motor is almost equal to the length of the piston stroke.

19. Device according to claim 18, characterized in that the armature of the electric motor is connected to the piston by a rod.

20. Device according to claim 19, characterized in that the armature forms a part of said rod.

21. Device according to claim 13, characterized in that the head of the high temperature piston shows in the opposite direction of the piston head of the secondary piston.

22. Device according to claim 13, characterized in that part of said rod is combined with a magnetic cylinder which cooperates with a stator with windings to produce electricity.

23. Device according to claim 22, characterized in that the magnetic cylinder is partitioned into regions with alternating polarity.

24. Device according to claim 22, characterized in that the magnetic cylinder produces alternating current in the stator with windings.
